(19) United States
(12) Patent Application Publication
(10) Pub. No.: US 2026/0264896 A1
(43) Pub. Date: Sep. 10, 2026

(54) UNMANNED AERIAL VEHICLE SYSTEM WITH INTEGRATED FIRE SUPPRESSION AND WINDOW-BREAKING PROJECTILE MECHANISM

(71) Applicant: Eagle Eye Robotics, Greensboro, NC (US)

(72) Inventor: Alec Rivosa, Greensboro, NC (US)

(21) Appl. No.: 19/069,884

(22) Filed: Mar. 4, 2025

(51) Int. Cl. B64U 20/80; B64U 10/16; B64U 30/293; B64U 50/39; B64U 60/50; A62B 3/00; B64U 101/30; B64U 101/47; B64U 101/55; F41B 4/00

(52) U.S. Cl. CPC B64U 20/80; B64U 10/16; B64U 30/293; B64U 50/39; B64U 60/50; A62B 3/005; B64U 2101/30; B64U 2101/47; B64U 2101/55; B64U 2201/104; B64U 2201/20; F41B 4/00

(57) ABSTRACT

A fire extinguishing unmanned aerial vehicle (UAV) system is disclosed that is configured for autonomous or remotely operated fire suppression in high-rise buildings and hazardous environments. The UAV system includes a projectile launcher mounted to the UAV and configured to store and selectively discharge a plurality of projectiles. At least one of the projectiles contains a fire-extinguishing material for application to active fires. A controller is operatively coupled to the UAV and the projectile launcher, enabling precise targeting and deployment of projectiles. The projectile launcher is configured to selectively discharge at least one projectile to break a window of a building, creating an access point for fire suppression, or to apply the fire-extinguishing material directly onto a fire. The system enhances emergency response capabilities by enabling rapid, aerial intervention in fire-affected areas, improving safety and efficiency while reducing reliance on manual firefighting methods.

### TECHNICAL FIELD

This disclosure relates to the field of unmanned aerial vehicles (UAVs), specifically those designed for emergency response applications, including fire suppression and hazardous environment operations.

### BACKGROUND

Firefighting operations in high-rise buildings and confined spaces pose significant challenges due to limited access, poor visibility, and the inherent dangers of structural fires. Traditional methods of horizontal ventilation and fire suppression often require extensive manpower, specialized equipment, and prolonged response times, increasing the risk to both firefighters and building occupants. Additionally, conventional techniques may be hindered by logistical constraints such as obstructed entry points, hazardous structural conditions, and the need for heavy mechanical tools. The growing urban landscape and the increasing height of modern buildings further complicate fire response efforts, necessitating the development of advanced aerial technologies to improve efficiency, safety, and accessibility in fire suppression operations.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying figures of which:

FIG. 1A is a top, perspective view of a UAV system in an unfolded state, in accordance with aspects of this disclosure;

FIG. 1B is a bottom, perspective view of the UAV system of FIG. 1A;

FIG. 2 is a block diagram of a controller assembly of the UAV system of FIGS. 1A and 1B;

FIG. 3A is a top, plan view of the UAV system in a folded state;

FIG. 3B is a top, cross-sectional view of a portion of a propulsion assembly of the UAV system in the folded state as shown in FIG. 3A, the view illustrating additional detail of the portion of the propulsion assembly in the folded state;

FIG. 4A is a top, plan view of the UAV system in a partially unfolded state;

FIG. 4B is a top, cross-sectional view illustrating additional detail of the portion of the propulsion assembly in the partially unfolded state as shown in FIG. 4A;

FIG. 5A is a top, plan view of the UAV system in an unfolded state;

FIG. 5B is a top, cross-sectional view illustrating additional detail of the portion of the propulsion assembly in the unfolded state as shown in FIG. 5A;

FIGS. 6A and 6B are perspective views of a projectile launcher of the UAV system of FIGS. 1A and 1B;

FIGS. 7A-7D are schematic, progressive views illustrating a firing assembly of the projectile launcher of FIGS. 6A and 6B discharging a first projectile from a firing position and advancing second and subsequent projectiles of the projectile launcher toward the firing position for selectively being subsequently discharged in succession from the firing assembly;

FIG. 8 is a top, perspective view of the UAV system illustrating a quick release, hot swappable, battery replacement;

FIGS. 9-11 are progressive views illustrating the UAV system in flight adjacent to a burning building and discharging window-breaking and fire-extinguishing projectiles through a window of the burning building;

FIG. 12 is a graph showing an exemplary flight time of the UAV system as projectiles of the projectile launcher of the UAV system are discharged; and

FIG. 13 is a graph showing an exemplary battery capacity consumption of the UAV system in relation to projectiles being discharged from the projectile launcher.

Further details and aspects of exemplary aspects of the disclosure are described in more detail below with reference to the appended figures. Any of the above aspects and aspects of the disclosure may be combined without departing from the scope of the disclosure.

### DETAILED DESCRIPTION

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

This disclosure provides a system and method for fire extinguishing using an unmanned aerial vehicle (UAV) system equipped with a projectile launcher, designed to address the challenges of firefighting in high-rise buildings and hazardous or remote locations. Traditional fire suppression methods require direct access to affected areas, which can be time-consuming and dangerous, especially when entry points are obstructed, fire spreads rapidly, or structures become unstable. Additionally, breaking windows for ventilation (e.g., horizontal ventilation) or access to suppress flames often requires manual effort and specialized equipment, further delaying intervention. To overcome these limitations, the disclosed UAV-based fire extinguishing system offers a safer and more efficient alternative.

Equipped with a projectile launcher, the UAV system can carry and discharge multiple projectiles, at least one of which contains fire extinguishing material, enabling both window-breaking and fire suppression capabilities. The foldable arms of the UAV system enable compact storage and easy transport when retracted inwardly. To facilitate flight and rapid deployment in emergencies, the foldable arms are extended outwardly. In aspects, a controller assembly of the UAV system includes a global positioning system, a controller, and avionics to ensure precise operation. The UAV system also incorporates an advanced sensor system, utilizing cameras, lights, and/or any other suitable sensors to accurately identify, target, analyze and/or monitor windows and fire zones, improving the effectiveness of fire suppression and window-breaking interventions.

By autonomously or remotely navigating fire-affected areas and bypassing physical obstacles, the UAV system enhances emergency response times while minimizing risks to human responders. This innovative system provides first responders with a crucial tool to combat fires from a safe distance, improving overall firefighting efficiency in environments where traditional methods may be impractical or too dangerous.

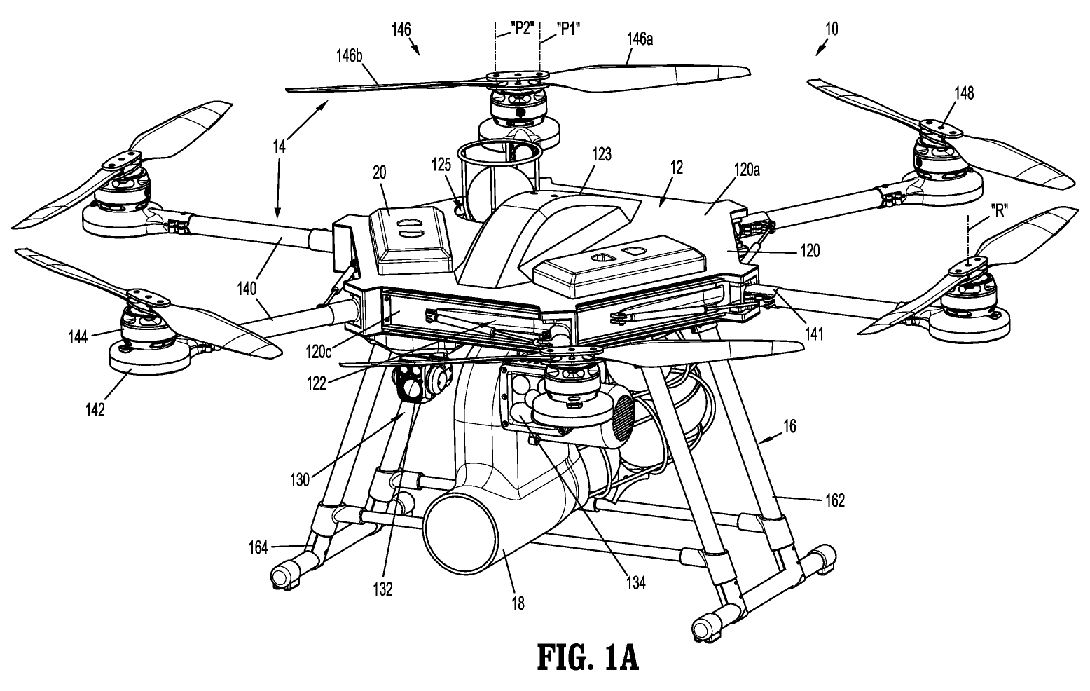

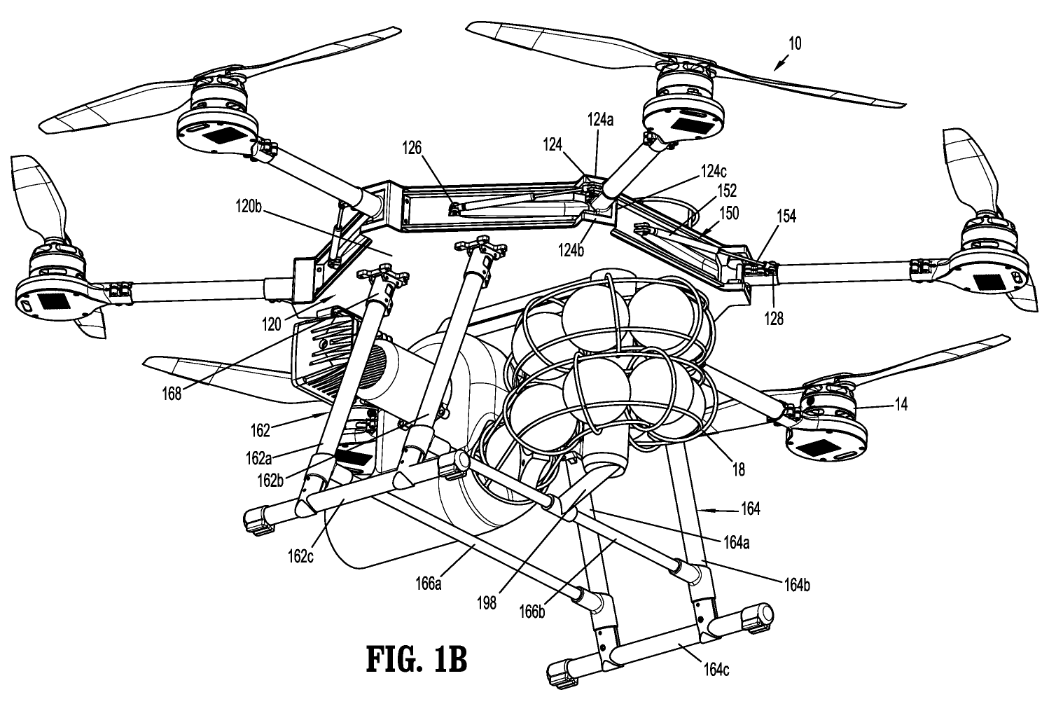

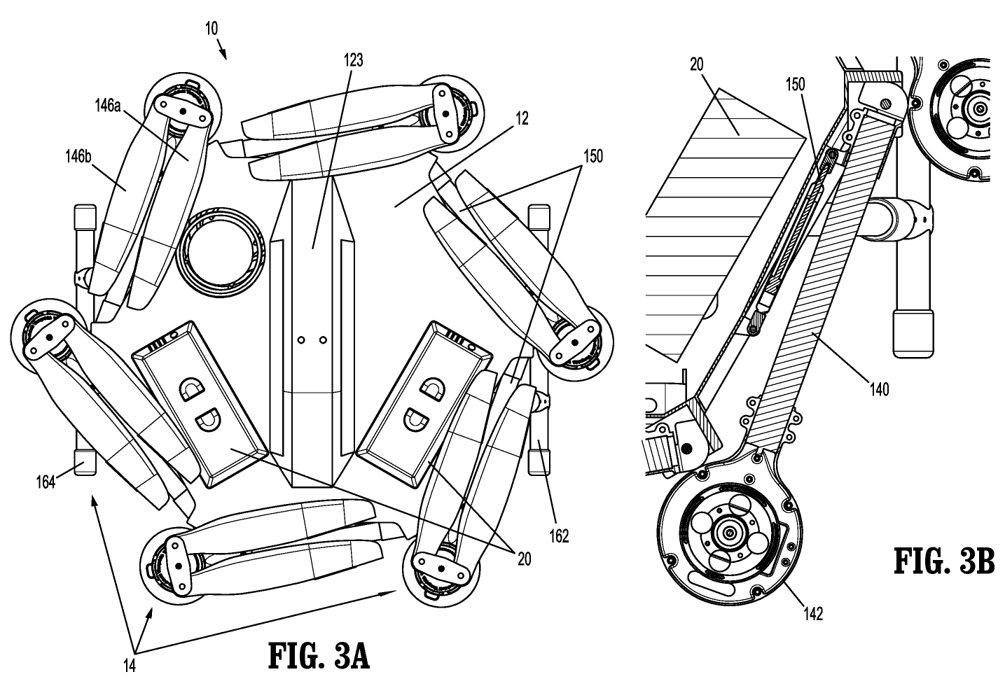

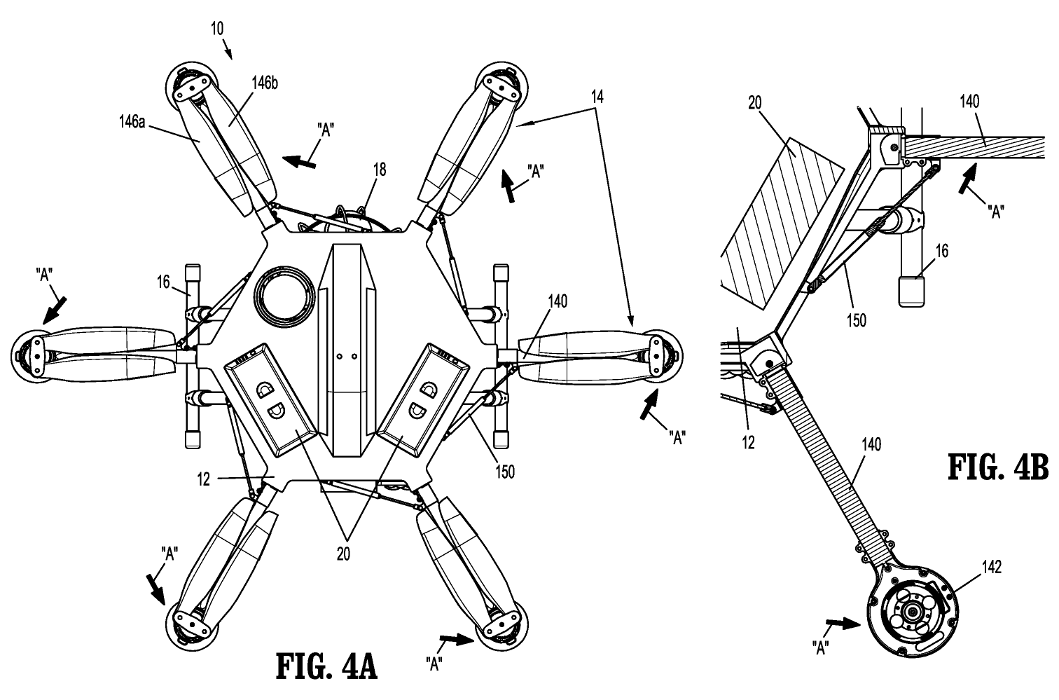

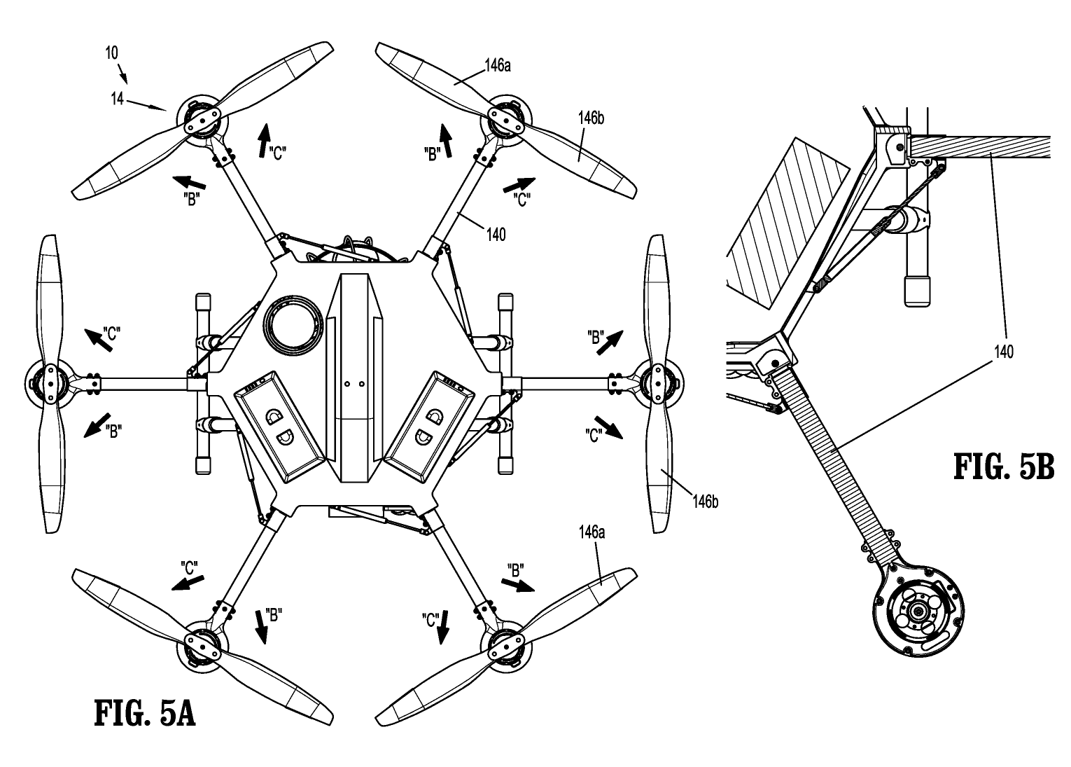

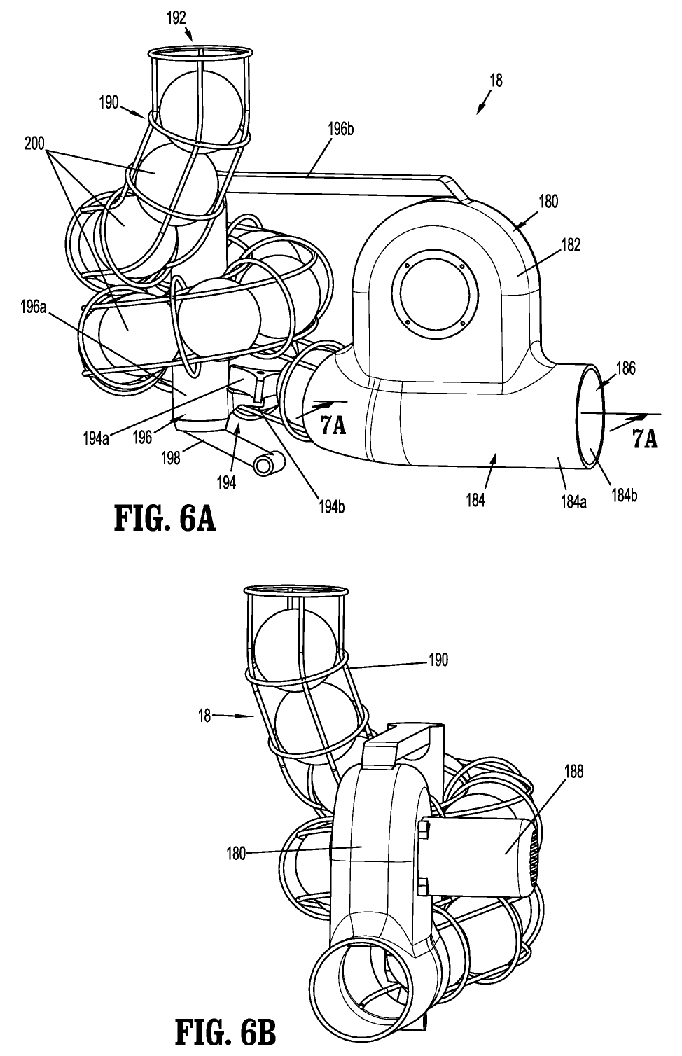

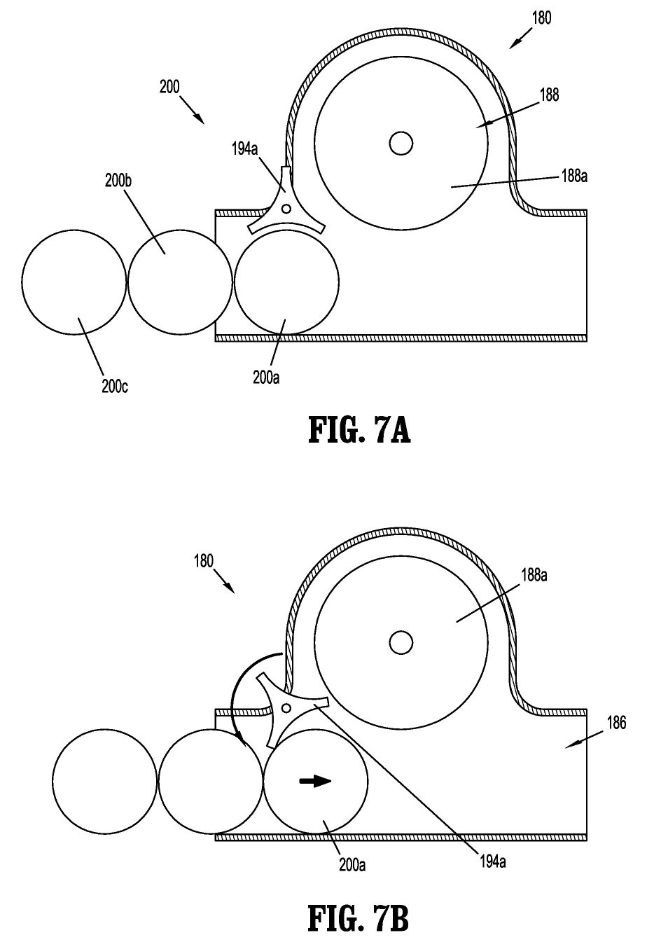

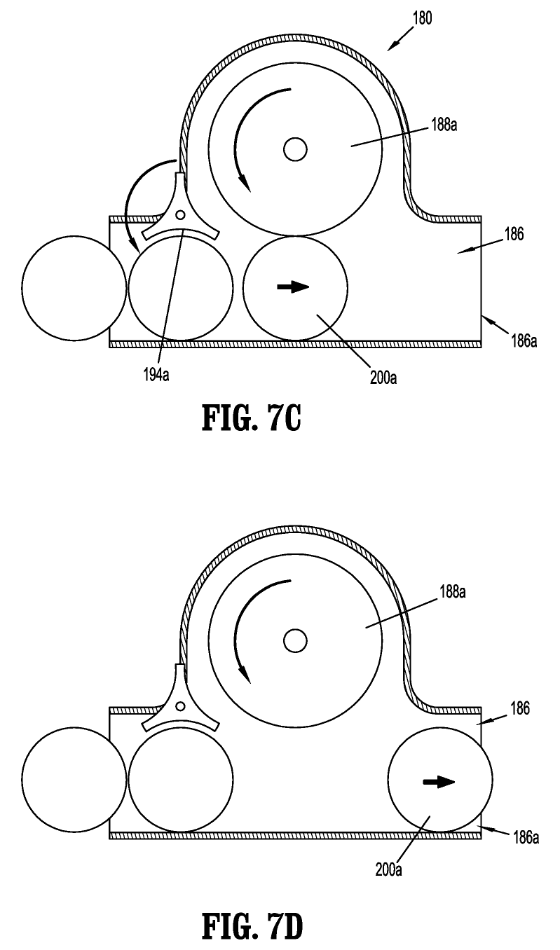

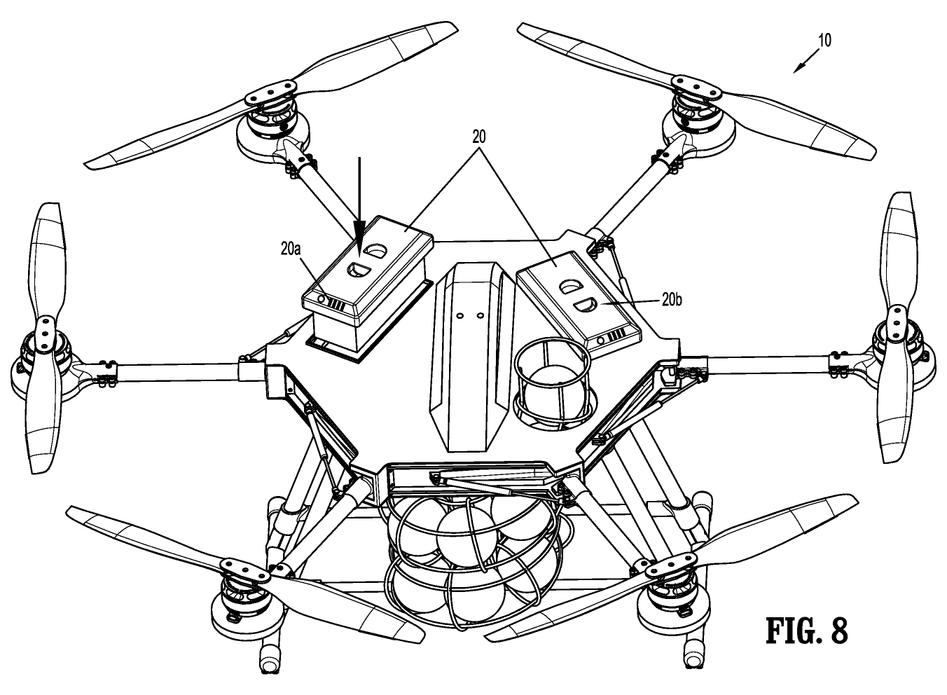

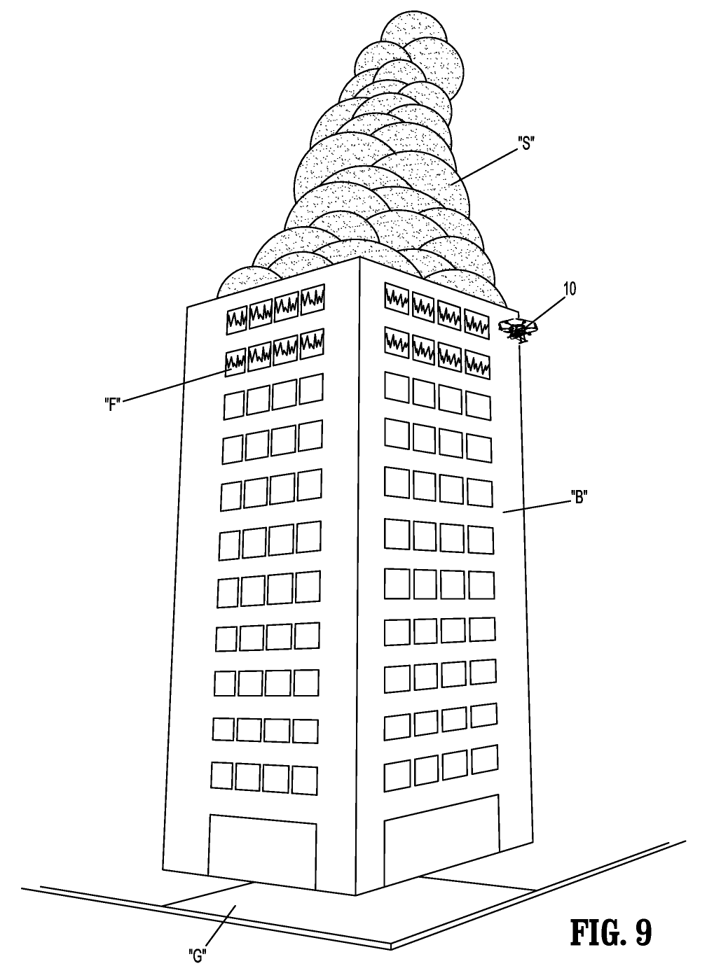

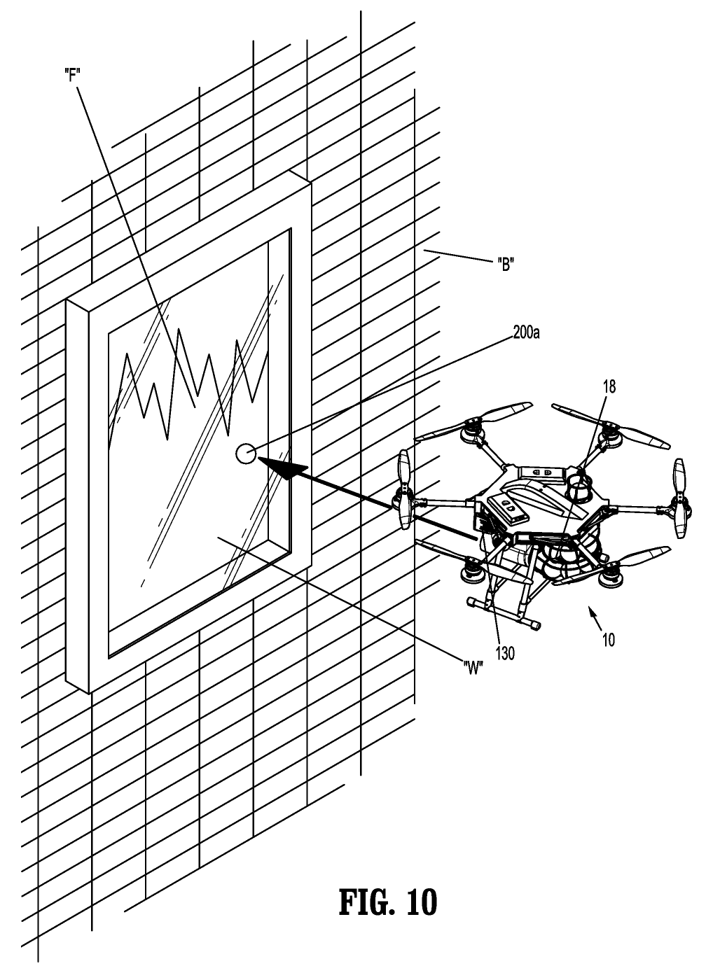

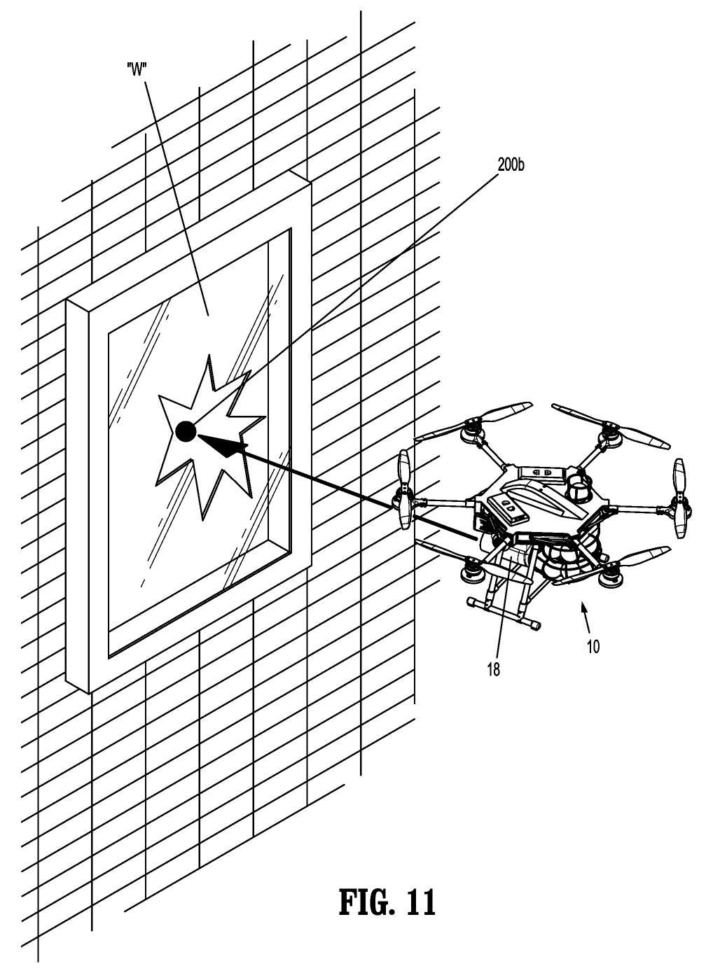

Turning now to FIGS. 1A and 1B, UAV system 10 includes a body assembly 12 that supports a plurality of propulsion assemblies 14 that are movable between a folded state (or a retracted position) (FIG. 3A) for facilitating storage, a partially unfolded state (or a partially extended position) (FIG. 4A) to prepare the UAV system for flight, and an unfolded state (or an extended position) (FIG. 5A) for facilitating flight of the UAV system 10. The UAV system 10 further includes a support leg assembly 16 depending from the body assembly 12 that provides stability to UAV system 10 during landing and takeoff. The body assembly 12 further supports a projectile launcher 18 configured to selectively discharge projectiles 200 (see e.g., FIGS. 6A, 6B, and 7A to 7D) for breaking windows “W” in burning buildings “B” and for applying fire extinguishing materials to fires “F” within the burning buildings “B” (see e.g., FIGS. 9-11). The body assembly 12 also supports quick release, hot swappable batteries 20 (see e.g., FIG. 8) for powering the UAV system 10.

With continued reference to FIGS. 1A and 1B, the body assembly 12 of UAV system 10 includes a main body 120 having a top surface 120a, a bottom surface 120b, and a side surface 120c that extends between the top and bottom surfaces 120a, 120b. At each location of a plurality of spaced-apart locations about a periphery of the main body 120, the side surface 120c defines a spring recess 122 and includes a stop wall 124 configured to support the respective propulsion assembly 14 of the plurality of propulsion assemblies in the extended position to facilitate flight of the UAV system 10. The stop wall 124 has a C-shaped configuration and includes a top wall 124a, a bottom wall 124b, and a side wall 124c that extends between the top and bottom walls 124a, 124b and functions as an abutment for the respective propulsion assembly 14. The top and bottom walls 124a, 124b pivotably support the respective propulsion assembly 14 to enable the respective propulsion assembly 14 to rotate between retracted and extended positions. At the respective location, a body spring mount 126 extends from the side surface 120c of the body assembly 12 and a propulsion spring mount 128 extends from a proximal portion of the respective propulsion assembly 14. A first end of a spring assembly 150 couples to the body spring mount 126 and second end of the spring assembly 150 couples to the propulsion spring mount 128 so that the body spring mount 126 and the propulsion spring mount 128 enable the spring assembly 150 to pivot relative to the body assembly 12 and the propulsion assembly 14, respectively, as the spring assembly 150 translates between extended and retracted positions to facilitate movement of the propulsion assembly 14 between extended and retracted positions. The spring assembly 150 includes a first spring segment 152 (e.g., a cylinder) and a second spring segment 154 (e.g., a piston) that translates relative to the first spring segment 152. The respective spring recess 122 receives the spring assembly 150 therein when the respective propulsion assembly 14 is disposed in the retracted position.

The main body 120 of UAV system 10 supports a controller assembly 123 and defines a body channel 125 that extends through the top and bottom surfaces 120a, 120b of the body assembly 12 for passing the projectiles 200 in the projectile launcher 18 through the body assembly 12.

A sensor assembly 130 is secured to the body assembly 12 and operatively coupled to the controller assembly 123. The sensor assembly 130 includes, for example, a camera assembly 132, a light assembly 134, and/or any other suitable sensors for enabling environments and/or objects such as buildings, fires, windows, and/or projectiles, etc. to be identified, analyzed, targeted, and/or monitored by controller assembly 123 and/or a remote operator of UAV system 10. In aspects, the sensor assembly 130 of the UAV system includes an advanced suite of detection technologies (not explicitly shown), including high-resolution optical cameras, thermal imaging sensors, LiDAR, and/or infrared sensors. These sensors provide comprehensive real-time analysis of fire conditions, enabling the UAV system to determine heat intensity, fire progression, and window integrity before launching projectiles. For example, thermal imaging sensors detect hotspots within the burning structure, identifying the most effective entry points for fire suppression. In another example, LiDAR sensors map the building's surface and provides precise distance calculations, ensuring optimal UAV positioning. In still another example, infrared sensors assess smoke density and visibility conditions, aiding in automated adjustments to the approach of the UAV system 10 and projectile targeting systems.

Each propulsion assembly 14 of UAV system 10 includes a foldable arm 140 that is pivotably coupled to body assembly 12 by an arm coupler 141 on a proximal end portion of the foldable arm 140. Indeed, foldable arm 140 pivots from a retracted position (FIGS. 3A and 3B) to an extended position (FIGS. 4A and 4B), as indicated by arrows “A.” In aspects, foldable arm 140 is self-locking when disposed in the retracted position and may have a pull-to-open configuration. The arm coupler 141 includes the propulsion spring mount 128. A distal end portion of the foldable arm 140 includes an electronic control system (ECS) 142 that is operatively coupled to controller assembly 123 and a motor 144 mounted to ECS 142. A propeller assembly 146 is secured to the motor 144 and includes a first propeller 146a and a second propeller 146b that are each pivotably coupled to opposites sides of a propeller hub 148 rotatably mounted to the motor 144. With reference to FIGS. 1A and 5A, the first propeller 146a is pivotable about a first pivot axis “P1,” as indicated by arrows “B,” and the second propeller 146b is pivotable about a second pivot axis “P2” (see FIG. 1A), as indicated by arrows “C,” such that the first and second propellers 146a, 146b are pivotable between a retracted position (FIGS. 3A and 4A) and an extend position (FIG. 5A) when the foldable arm 140 is disposed in an extended position (see FIGS. 4A and 5A). The motor 144 defines an axis of rotation “R” about which the first and second propeller 146a, 146b rotate when the first and second propellers 146a, 1456b are disposed in an extended position (FIGS. 1A, 1B and 5A). The axis of rotation “R” extends through a center of the propeller hub 148, a center of the motor 144, and a center of the ECS 142. The ECS 142 is configured to operate the motor 144 to enable the first and second propellers 146a, 146b to rotate about the axis of rotation “R” to enable the UAV system 10 to fly.

The support leg assembly 16 includes a first leg assembly 162 on a first side of the UAV system 10 and a second leg assembly 164 on a second side of the UAV system 10 opposite to the first leg assembly 162 and connected by a front cross bar 166a and a rear cross bar 166b. The first leg assembly 162 includes a first front leg 162a and a first rear leg 162b coupled together by a first foot 162c on lower ends of the first front and rear legs 162a, 162b. Upper ends of the first front and rear legs 162a, 162b are secured to the bottom surface 120b of the main body 120 by leg mounts 168. Similarly, the second leg assembly 164 includes a second front leg 164a and a second rear leg 164b coupled together by a second foot 164c on lower ends of the second front and rear legs 164a, 164b. Upper ends of the second front and rear legs 164a, 164b are secured to the bottom surface 120b of the main body 120 by leg mounts 168.

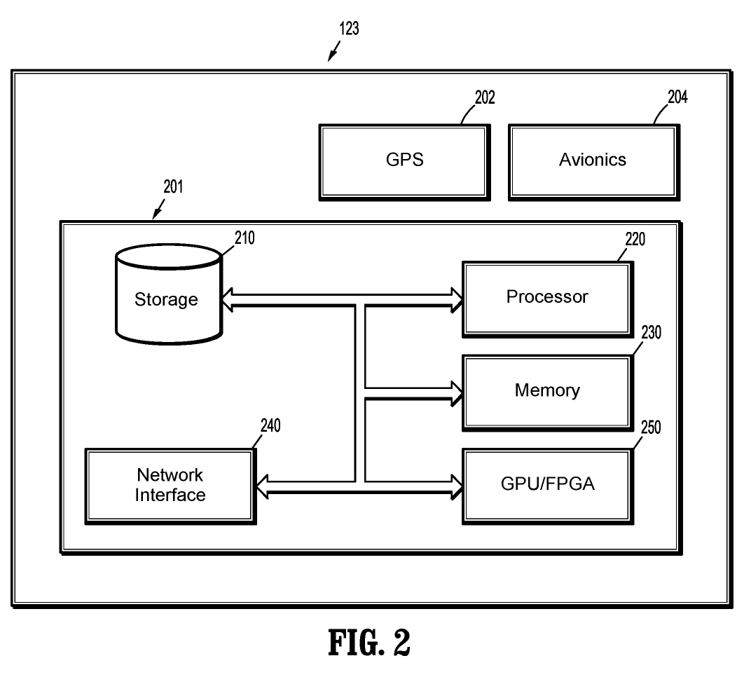

FIG. 2 illustrates a schematic diagram of the controller assembly 123 of the UAV system 10. The controller assembly 123 comprises a controller 201, a global positioning system (GPS) 202, and avionics 204, which together enable flight control, navigation, and real-time decision-making. The controller 201 integrates multiple processing components, including storage 210, processor 220, memory 230, network interface 240, and graphics processing unit (GPU)/ Field-Programmable Gate Array (FPGA) module 250, ensuring efficient operation of UAV system 10, data management, and communication with external systems.

The storage 210 is a non-volatile memory component responsible for retaining essential flight data, mission parameters, system logs, and pre-programmed navigation routes. It may include solid-state drives, flash memory, or other high-capacity storage technologies. The processor 220 serves as the central processing unit (CPU), executing real-time flight commands and managing critical functions such as sensor data processing, flight stabilization, obstacle detection, and navigation computations. To support high-speed data access, the memory 230 acts as a volatile storage system, temporarily holding sensor inputs, image processing outputs, and AI-driven calculations to ensure uninterrupted UAV system operations during flight.

In aspects, the memory 230 of the controller assembly 123 stores a predefined set of window-breaking parameters based on common architectural glass types, including tempered glass, laminated glass, and reinforced glass. The processor 220 analyzes data from the sensor assembly 130 to assess the thickness and structural composition of the target window “W” (see FIG. 9) before launching a projectile 200. Using machine-learning algorithms, the controller 201 calculates the minimum required impact force and adjusts projectile velocity accordingly. If the detected glass type exceeds the pre-set threshold for breakage, the UAV system 10 may select a higher-density projectile or adjust the projectile launcher 18 to deliver increased kinetic energy, for instance, by increasing an operating speed of a motor assembly 188 (see FIG. 6B) of projectile launcher 18. Additionally, if multiple windows “W” (see FIG. 9) are present, the processor 220 determines the weakest entry point for optimal breakage while minimizing structural risks.

Before deploying a fire-extinguishing projectile, the controller 201 evaluates multiple factors to determine the optimal entry point for suppression. In aspects, the sensor assembly 130 continuously analyzes fire intensity, airflow patterns, and structural layout, ensuring the projectile 200 is launched at the most effective location. The UAV system 10 accounts for natural and artificial ventilation points, such as open or broken windows, doorways, and roof vents, to predict fire spread and optimize extinguishing material deployment. Additionally, in aspects, the controller 201 includes onboard artificial intelligence (AI) that is configured to simulate airflow dynamics within the burning structure, preventing backdraft risks and ensuring that the extinguishing agent reaches the core of the fire zone. These calculations help prevent reignition and maximize suppression efficiency.

The network interface 240 enables the UAV system 10 to establish both wireless and wired communication with remote control stations, ground-based servers, or cloud-based AI processing systems. This module supports a range of communication protocols such as Wi-Fi, LTE, 5G, satellite communication, or proprietary radio frequency (RF) links, allowing seamless data transmission and remote control of the UAV system 10. The GPU/FPGA module 250 is a high-performance computing unit designed to accelerate complex processing tasks such as image recognition, real-time video streaming, AI-driven navigation, and secure data handling. The inclusion of a GPU enables enhanced machine learning applications, while an FPGA enables hardware-level optimizations tailored to autonomous flight control and mission-critical decision-making.

As a subcomponent of the controller assembly 123, the controller 201 operates alongside GPS 202 and avionics 204 to enhance UAV functionality. The GPS 202 provides precise positioning and waypoint-based navigation, ensuring the UAV can autonomously follow predefined routes or adjust the flight path in real time. The avionics 204 system includes sensors and stabilization algorithms that maintain flight stability, monitor environmental conditions, and assist in executing advanced maneuvers.

The operational workflow of the controller 201 begins with retrieving flight parameters and mission objectives from storage 210, which are then processed by processor 220 to determine optimal navigation path of the UAV system 10. The memory 230 temporarily stores sensor inputs and computational data, allowing for real-time adjustments based on environmental feedback. The network interface 240 facilitates continuous communication between the UAV system 10 and external operators, enabling remote command execution and live telemetry monitoring. The GPU/FPGA module 250 enhances AI-based decision-making, including obstacle detection, target identification, and adaptive flight control.

This integrated controller assembly 123, comprising controller 201, GPS 202, and avionics 204, enables key UAV system 10 functionalities such as autonomous flight, AI-enhanced navigation, obstacle avoidance, and mission adaptability. By leveraging high-performance computing and robust communication systems, the UAV system 10 is capable of operating effectively in various scenarios, including fire rescue, reconnaissance, and tactical missions. The controller 201 is configured to balance computational efficiency with power management, maximizing UAV system 10 endurance while maintaining precise control and situational awareness.

The controller 120 is further configured to analyze real-time environmental conditions, including wind speed, temperature, and smoke density, to optimize the trajectory of projectiles 200 before discharge. In aspects, the UAV system 10 is equipped with onboard environmental sensors (not explicitly shown), including anemometers, barometers, and gas sensors, that provide continuous data on atmospheric conditions. These inputs are processed by the processor in real-time, adjusting the launch angle, projectile velocity, and UAV positioning to compensate for external factors. Using AI-driven trajectory prediction algorithms, the controller 120 dynamically modifies projectile discharge settings, ensuring high accuracy in hitting targeted windows or fire zones despite adverse conditions such as high winds, excessive heat, or turbulence caused by rising smoke.

FIGS. 6A and 6B illustrate different views of the projectile launcher 18 of UAV system 10 for controlled projectile deployment. The projectile launcher 18 provides projectile storage, indexing, and firing to ensure precise projectile launching capabilities.

In FIG. 6A, the projectile launcher 18 includes a projectile magazine 190 (e.g., a 12 slot magazine) defining a magazine inlet 192, which serves as the entry point for loading projectiles 200 into the projectile magazine 190, and which enables “no tool” reloading. In aspects, to limit weight of the UAV system 10, projectile magazine 190 is in the form of an open aluminum cage. The projectile magazine 190 provides storage and secure positioning of projectiles 200 before deployment. A support arm assembly 196 of projectile launcher 18, which includes a first support arm 196a and second support arm 196b, reinforces the structural stability of the projectile magazine 190 and to the projectile launcher 18, generally. A cross bar connector 198 of support arm assembly 196 extends from first support arm 196a at an angle and links the supporting arm assembly 196 to the rear cross bar 166b of support leg assembly 16 for additional reinforcement (see e.g., FIG. 1B).

The indexer assembly 194 of projectile launcher 18 includes an indexer 194a and a servo motor 194b (e.g., a 360 degree servo motor) that is coupled to indexer 194a and configured to rotate indexer 194a for selectively sequentially releasing one projectile 200 (e.g., one ball) at a time. Although only a single indexer is shown, any number or arrangement of indexers may be provided to facilitate sequential positioning of the projectiles 200 into a firing assembly 180 of projectile launcher 18. The firing assembly 180 is enclosed within a motor housing 182 and directs projectiles 200 through a conduit 186 defined by an inner surface 184b of a projectile tube 184 to ensure a stable launch trajectory. The projectile tube 184 further includes an outer surface 184a that is integrally formed with motor housing 182. The servo motor 194b is operatively coupled to controller assembly 123 and is configured to receive signals or command from controller 201 for selectively actuating servo motor 194b to rotate indexer 194a. In aspects, the signal or command can be initiated by a ground control station and/or remote operator disposed in communication with control assembly 123.

FIG. 6B provides an alternate perspective of the projectile launcher 18, highlighting a motor assembly 188 of firing assembly 180, which projects from a side surface of motor housing 182. The motor assembly 188 powers projectile propulsion, ensuring consistent and controlled firing.

Together, these figures illustrate the detailed structure of the projectile launcher assembly 18, showcasing its ability to store, index, and launch projectiles in a controlled manner. This system is particularly useful for UAV operations that require target engagement, breaching capabilities, or emergency response applications such as fire suppression, ensuring that projectiles are accurately deployed toward designated targets.

FIGS. 7A through 7D illustrate progressive, schematic views of a firing sequence for projectiles 200 from the firing assembly 180 of projectile launcher 18. The firing sequence involves sequential indexing, positioning, and propulsion of the projectiles 200 for deployment through the conduit 186 of the firing assembly 180.

In FIG. 7A, a first projectile 200a (e.g., a window-breaking ball, which may include, for example, a ridge material such as aluminum or any other suitable material) is in a standby position relative to the indexer 194a, alongside a second projectile 200b (e.g., a first fire-extinguishing ball including fire-extinguishing material) and a third projectile 200c (e.g., a second fire-extinguishing ball including fire-extinguishing material which may be the same or different than the fire-extinguishing material in the first fire extinguishing ball), which remain in storage (e.g., within projectile magazine 190). In aspects, projectiles 200 may have any suitable diameter such as a 74mm diameter. The indexer 194a is shown in a first pre-firing position, blocking the first projectile 200a from advancing. A firing wheel 188a of the motor assembly 188, is disposed in a static state, ready to engage the first projectile 200a upon activation.

In FIG. 7B, the indexer 194a begins to rotate when servo motor 194b rotates in response to receiving an advancing signal or command from the control assembly 123, urging the first projectile 200a forward toward the firing wheel 188a.

In FIG. 7C, the firing wheel 188a rotates when motor assembly 180 is actuated in response to receiving an actuation signal from the controller 201 of the control assembly 123. A periphery of the firing wheel 188a exerts rotational force from firing wheel 188a into a tangential/centrifugal force (e.g., a linear force) that acts on the first projectile 200a and accelerates the first projectile 200a through the conduit 186 toward a discharge opening 186a of the conduit 186.

In FIG. 7D, the first projectile 200a is launched/discharged through the discharge opening 186a of the conduit 186. Meanwhile, the indexer 194a is reset to a second pre-firing position (e.g., rotated 120 degree from first pre-firing position as shown) to ensure that the second projectile 200b remains in place until the next firing sequence to prevent additional projectiles 200 from advancing until the next activation. This staged approach ensures precise, controlled projectile deployment. This sequence repeats when another firing signal is sent to the motor assembly 188 and/or servo motor 194b.

This series of figures demonstrates a structured and automated firing process, utilizing an indexing mechanism, a motorized firing wheel, and conduit system to effectively launch projectiles. The controlled sequence minimizes jamming risks and ensures accurate projectile discharge, making the system suitable for UAV applications requiring target engagement, breaching operations, or emergency response interventions.

FIG. 8 illustrates the dual battery system of the UAV system 10, highlighting the hot-swappable battery configuration designed for extended flight operations. The UAV system 10 is equipped with two high-capacity 11,000 mAh batteries 20, enabling redundant power management and seamless replacement without interrupting UAV functionality. These batteries 20 are mounted on the main body 120 of the UAV system 10 and are designed to be easily removed and replaced in the field.

Each battery 20 features a state-of-health (SoH) indicator 20a, which provides real-time feedback on the battery’s condition, including charge level, voltage status, and overall battery health. This indicator ensures that operators of the UAV system 10 can monitor battery performance and replace degraded units before they impact flight performance.

To facilitate easy removal and replacement, the batteries 20 are also equipped with finger holes 20b, enabling operators to securely grip and extract the batteries 20 without the need for additional tools. This hot-swappable design enables continuous operation of the UAV system by enabling one of the batteries 20 to be replaced while the UAV system 10 remains powered by the other battery 20, thereby minimizing downtime.

The inclusion of dual hot-swappable batteries 20 enhances the operational endurance of the UAV system 10, making such structure ideal for long-duration missions, including surveillance, emergency response, and tactical applications. The 11,000 mAh capacity provides significant energy storage, supporting high-power functions such as propulsion, onboard processing, and payload deployment (e.g., firing of projectiles 200) without compromising flight time.

Overall, FIG. 8 demonstrates an efficient, field-adaptable power solution for UAV operations, ensuring reliability, extended flight capabilities, and ease of maintenance.

FIGS. 9 through 11 illustrate a sequence of UAV operations involving fire detection, window breaching, and fire suppression deployment in an emergency scenario.

In FIG. 9, the UAV system 10 is deployed near a burning building “B,” where fire “F” is visible, and smoke “S” is emanating from the upper floors. The UAV system 10 hovers near the building “B” to assess the situation, utilizing sensor assembly 130, including, for instance, camera assembly 132 and/or light assembly 134 for enabling real-time imaging and monitoring of the fire “F” to help determine an optimal intervention point, such as a targeted window “W” that is closed or open.

In FIG. 10, the UAV system 10 identifies a window “W” near the fire “F” and aligns projectile launcher 18 of UAV system 10 to deploy a first projectile 200a. The sensor assembly 130 aids in precision targeting, ensuring the first projectile 200a impacts the window “W” at an optimal location for breakage when such window “W” is closed (or at least partially closed). The first projectile 200a is configured to shatter the window “W,” creating an access point (or improved access) for additional firefighting measures.

In FIG. 11, after successfully breaking the window “W” (or after identifying an open window “W”), the UAV system 10 launches a second projectile 200b through the breached window “W.” The second projectile 200b includes one or more fire-extinguishing materials, which are deployed upon impact inside the burning building “B” to suppress or slow the spread of the fire “F.”

As can be appreciated, fire extinguishing materials are designed to suppress or extinguish fires by eliminating heat, oxygen, or fuel sources. These materials can be categorized based on their composition and effectiveness against different classes of fires. The fire extinguishing materials of one or more of the projectiles 200, such as second projectile 200b, may include water-based agents, dry chemical agents, foam-based agents, gas-based agents, wet chemical agents, and/or powder-based agents.

Water-based agents are commonly used due to their cooling properties. Standard water extinguishers work by reducing the temperature of burning materials, making them effective for Class A fires involving ordinary combustibles like wood, paper, and textiles. Water mist, a fine spray of tiny water droplets, is also effective in cooling flames and displacing oxygen, making it suitable for sensitive environments such as electrical fires where traditional water use could cause further hazards.

Dry chemical agents are widely used in fire extinguishers. Monoammonium phosphate is a multipurpose agent effective against Class A, B, and C fires by smothering flames and interrupting the chemical reaction of combustion. Sodium bicarbonate, commonly found in extinguishers for Class B and C fires, releases carbon dioxide upon decomposition, cutting off oxygen supply. Potassium bicarbonate, often referred to as Purple-K, is highly effective in industrial and aviation fire suppression due to its superior ability to smother flames compared to sodium bicarbonate. Potassium chloride is another dry chemical alternative that works similarly by displacing oxygen.

Foam-based agents create a protective barrier between the fire and the surrounding air. Aqueous Film-Forming Foam (AFFF) spreads a thin film over flammable liquids, such as gasoline or jet fuel, preventing the release of vapors that sustain combustion. Alcohol-resistant AFFF (AR-AFFF) is formulated for fires involving polar solvents, such as ethanol or methanol, that could otherwise break down standard foams. High-expansion foams are particularly useful for enclosed spaces, such as tunnels or aircraft hangars, where they fill an area with foam to suffocate the fire.

Gas-based agents are clean and leave no residue, making them ideal for use in environments containing sensitive electronics or valuable equipment. Carbon dioxide (CO₂) is a common extinguishing agent that displaces oxygen, effectively suffocating Class B and C fires. Halon 1211 and Halon 1301 were historically used for high-risk environments, such as aviation and server rooms, but have largely been phased out due to environmental concerns. Alternative halon replacements, such as Halotron and Novec 1230, provide similar extinguishing capabilities while being more environmentally friendly. FM-200, another halon alternative, is widely used in fire suppression systems for data centers and mission-critical facilities.

Wet chemical agents are particularly effective for kitchen fires involving cooking oils and fats (Class K fires). These extinguishers typically contain potassium acetate, potassium citrate, or potassium carbonate, which form a soapy layer over the burning oil, preventing reignition. Water mist systems infused with chemical additives are also used in industrial settings to enhance fire suppression.

Powder-based agents are specifically designed for metal fires (Class D), which involve combustible metals like magnesium, lithium, or titanium. Graphite powder, sodium chloride powder, and copper powder are commonly used to smother metal fires and prevent oxygen from reaching the burning material. Dry sand is another simple but effective agent for controlling metal fires in emergency situations.

In addition to these conventional agents, one or more of the projectiles 200 may include specialized fire suppression materials such as fire retardant gels, which coat surfaces to prevent ignition, aerosol fire suppression materials that release fine particles to disrupt the chemical chain reaction of a fire, and/or intumescent materials, which expand when exposed to high temperatures, creating a fire-resistant barrier that slows the spread of flames.

These various fire extinguishing materials provide targeted suppression strategies for different fire scenarios, making them essential for fire prevention and response in residential, commercial, industrial, and specialized environments.

With continued reference to FIG. 11, the UAV system 10 continues to monitor the behavior of fire “F” using camera assembly 132, providing real-time feedback to emergency responders so that one or more additional projectiles 200 can be discharged as necessary to further break the window and/or other windows “W” and/or to further dispense additional fire-extinguishing projectiles as the same and/or different locations.

The controller 201 is configured to continuously monitor fire suppression effectiveness using real-time data collected by the sensor assembly 130. After each projectile deployment, the UAV system 10 is configured to assesses fire conditions to determine whether additional projectiles are required. For instance, the thermal imaging sensor (not shown) checks for temperature reductions in the targeted area, while optical and infrared cameras of camera assembly 132 assess smoke density and flame behavior. If the fire persists, the UAV system 10 dynamically adjusts its strategy, deploying additional projectiles or recommending alternative suppressant types. The AI-based monitoring system generates predictive models for fire progression, enabling faster and more effective response times.

This sequence of operations demonstrates how the UAV system 10 integrates fire detection, precision targeting, and fire suppression into a single autonomous or remotely controlled response system. By employing sensor-guided projectile deployment, the UAV system 10 enhances firefighting efficiency, reduces response time, and minimizes risks for human responders in hazardous environments.

In aspects, the UAV system 10 is equipped with a dedicated communication module (e.g., as part of network interface 240) that transmits real-time fire suppression data to emergency response teams. In aspects, the UAV system 10 supports any number of communication protocols, including, for instance, Wi-Fi, LTE, 5G, and satellite uplink, ensuring stable connectivity even in remote or high-risk locations. In aspects, the real-time data transmission includes: live UAV Positioning (GPS-based location tracking), thermal and optical imagery of the fire zone, fire suppression effectiveness metrics (e.g., reduction in temperature, fire spread analysis), and/or battery and/or payload status (remaining fire suppression capacity). In certain aspects, the UAV system 10 integrates with cloud-based emergency management systems, enabling data storage, post-incident analysis, and training simulations to enhance future firefighting operations.

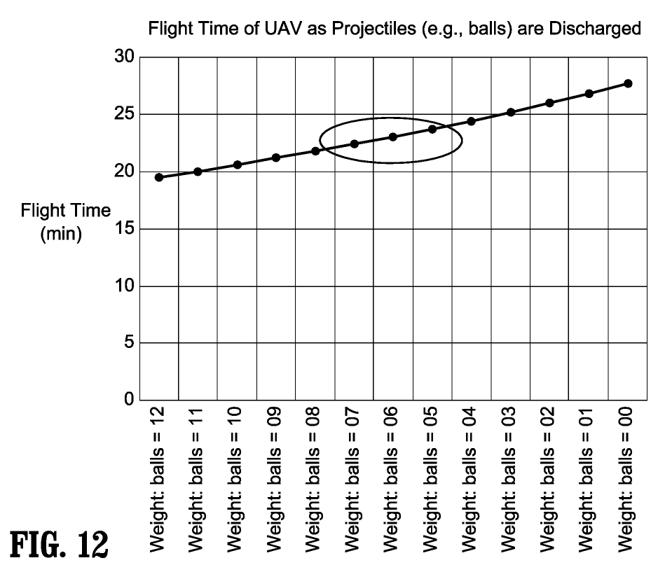

FIG. 12 illustrates a graphical representation of flight time of UAV system 10 as a function of payload weight, specifically the number of projectiles 200 carried. The x-axis represents the payload weight, measured in the number of balls (projectiles 200) carried by the UAV system 10, ranging from 12 balls (heaviest load) to 0 balls (no payload). The y-axis represents the total flight time in minutes, showing how the endurance of the UAV system 10 increases as the payload weight decreases.

The data points on the graph form a generally increasing trend, indicating that reducing the payload weight results in longer flight times. The lowest recorded flight time is observed at approximately 19-20 minutes when carrying 12 projectiles 200, while the highest flight time reaches nearly 28-30 minutes with no payload. The circled region highlights a range of weights where a notable change in flight duration occurs, namely, indicating an optimal balance between payload and operational efficiency.

This graph demonstrates how UAV endurance is directly affected by payload weight, emphasizing the tradeoff between carrying additional projectiles and maintaining extended flight capabilities. This information is crucial for mission planning, helping operators optimize payload distribution while ensuring sufficient flight time for firefighting, search and rescue, or tactical operations.

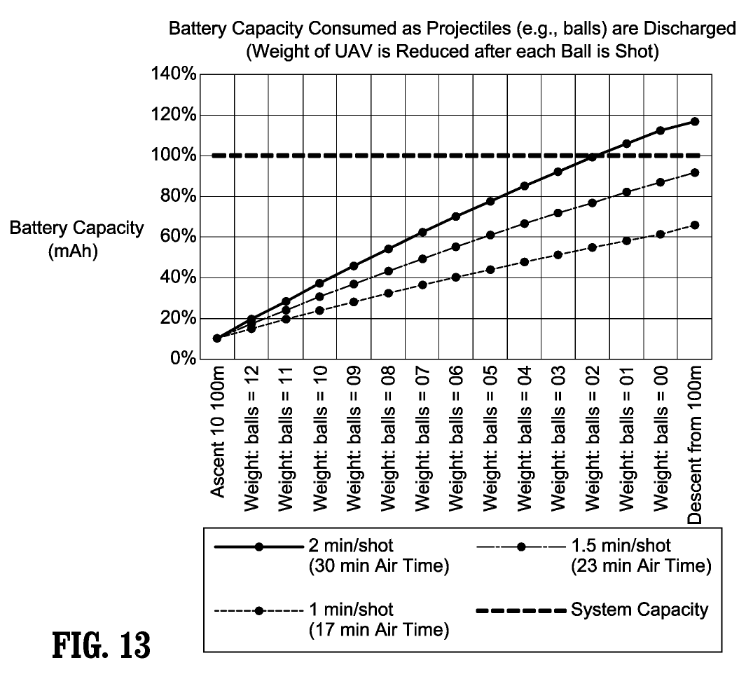

FIG. 13 illustrates a graph showing battery capacity consumption as a function of payload weight and projectile deployment rate for the UAV system 10. The x-axis represents different operational stages, including ascent to 100 meters, various payload weights (measured in the number of projectiles carried), and descent from 100 meters. The y-axis represents battery capacity consumption in milliampere-hours (mAh), expressed as a percentage of total system capacity.

The graph includes multiple data series representing different shot intervals, specifically, 2 minutes per shot (solid line, corresponding to approximately 30 minutes of total air time); 1.5 minutes per shot (dashed-dot line, corresponding to approximately 23 minutes of air time); 1 minute per shot (dotted line, corresponding to approximately 17 minutes of air time), and system capacity (thick dashed line) representing the maximum available battery capacity.

The data points indicate that battery consumption increases proportionally with payload weight. As the UAV system 10 carries more projectiles 200, it requires more energy to sustain flight, leading to greater power consumption over time. Additionally, the frequency of projectile deployment significantly affects battery usage. A higher shot rate (1 min/shot) results in faster battery depletion, whereas a lower shot rate (2 min/shot) allows for longer flight endurance.

This figure provides valuable insights into power management strategies for operations of UAV system 10, enabling operators to balance payload weight, firing frequency, and battery endurance to optimize mission performance. Understanding these trade-offs enables an operator to maximize UAV flight time in firefighting, tactical operations, and/or search-and-rescue missions.

It should be understood that the disclosed structure can include any suitable mechanical, electrical, and/or chemical components for operating the disclosed system or components thereof. For instance, such electrical components can include, for example, any suitable electrical and/or electromechanical, and/or electrochemical circuitry, which may include or be coupled to one or more printed circuit boards. As appreciated, the disclosed computing devices and/or server can include, for example, a “controller,” “processor,” “digital processing device” and like terms, and which are used to indicate a microprocessor or central processing unit (CPU). The CPU is the electronic circuitry within a computer that carries out the instructions of a computer program by performing the basic arithmetic, logical, control and input/output (I/O) operations specified by the instructions, and by way of non-limiting examples, include server computers. In some aspects, the controller includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the nonvolatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various aspects, the memory can be random access memory, read-only memory, magnetic disk memory, solid state memory, optical disc memory, and/or another type of memory. In various aspects, the memory can be separate from the controller and can communicate with the processor through communication buses of a circuit board and/or through communication cables such as serial ATA cables or other types of cables. The memory includes computer-readable instructions that are executable by the processor to operate the controller. In various aspects, the controller may include a wireless network interface to communicate with other computers or a server. In aspects, a storage device may be used for storing data. In various aspects, the processor may be, for example, without limitation, a digital signal processor, a microprocessor, an ASIC, a graphics processing unit (“GPU”), field-programmable gate array (“FPGA”), or a central processing unit (“CPU”).

Although illustrated as part of the disclosed structure, it is also contemplated that a controller may be remote from the disclosed structure (e.g., on a remote server), and accessible by the disclosed structure via a wired or wireless connection. In aspects where the controller is remote, it is contemplated that the controller may be accessible by, and connected to, multiple structures and/or components of the disclosed system.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IOT device, or a server system.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display includes vacuum fluorescent displays (VFD) and/or seven segment LED displays. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the disclosed apparatus, components thereof, and/or resources thereof. As used herein, the term “network” can include any network technology including, for instance, a cellular data network, a wired network, a fiber-optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Selfhealing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

In alternative aspects, the UAV system may incorporate artificial intelligence (AI)-driven fire detection and response optimization. Utilizing machine learning models trained on fire behavior patterns, the UAV system can predict fire spread and autonomously adjust its flight path and suppression strategies in real time. AI-enhanced thermal and optical imaging may further improve situational awareness by dynamically identifying high-risk zones, structural weaknesses, and optimal intervention points. Additionally, LiDAR-based Simultaneous Localization and Mapping (SLAM) may be implemented to enable the UAV system to autonomously navigate through smoke-filled or low-visibility environments while avoiding obstacles such as debris, power lines, or unstable structures.

In another aspect, the UAV system may be configured with an advanced projectile system capable of multi-stage deployment. For instance, the first projectile stage may be designed for breaking windows, while the second stage disperses a fire-suppressing agent, such as encapsulated retardant foam or aerosolized chemical suppressants. To enhance operational endurance, the UAV system may also integrate hybrid power solutions, such as hydrogen fuel cells in combination with lithium-ion batteries, to extend flight time while maintaining high power efficiency. Additionally, a mesh networking system may be employed to enable multiple UAV units to coordinate responses in large-scale fire incidents, enhancing coverage and effectiveness in urban and remote environments.

Further aspects of the present disclosure are provided by the subject matter of the following clauses.

A fire extinguishing unmanned aerial vehicle system includes an unmanned aerial vehicle (UAV), a projectile launcher, and a controller. The projectile launcher is secured to the UAV and configured to support a plurality of projectiles, wherein at least one of the projectiles includes a fire-extinguishing material. The controller is operatively coupled to the UAV and the projectile launcher, wherein the controller is configured to selectively discharge at least one projectile of the plurality of projectiles from the projectile launcher to break a window in a structure or apply fire extinguishing material to a fire in the structure with the at least one projectile.

The fire extinguishing unmanned aerial vehicle system according to the preceding clause, wherein the UAV includes a plurality of foldable arms that transition between a retracted position for compact storage and an extended position for flight.

The fire extinguishing unmanned aerial vehicle system according to any of the preceding clauses, wherein each foldable arm supports a motor and propeller assembly configured to enable flight of the UAV.

The fire extinguishing unmanned aerial vehicle system according to any of the preceding clauses, wherein the projectile launcher includes an indexing assembly configured to sequentially position the plurality of projectiles for deployment.

The fire extinguishing unmanned aerial vehicle system according to any of the preceding clauses, wherein the indexing assembly includes a rotatable indexer configured to selectively advance successive projectiles into a firing position.

The fire extinguishing unmanned aerial vehicle system according to any of the preceding clauses, wherein the projectile launcher includes a firing assembly having a firing wheel, wherein the firing wheel is configured to impart a rotational force onto each projectile to propel the projectile from the projectile launcher.

The fire extinguishing unmanned aerial vehicle system according to any of the preceding clauses, further comprising a camera assembly configured to capture real-time images of a fire.

The fire extinguishing unmanned aerial vehicle system according to any of the preceding clauses, wherein the plurality of projectiles includes a first projectile configured to break the window in the structure and a second projectile that includes the fire-extinguishing material, the second projectile is configured to be deployed through the window when the window is broken or open to provide horizontal ventilation or access to the fire within the building.

The fire extinguishing unmanned aerial vehicle system according to any of the preceding clauses, wherein the UAV comprises a dual battery system including hot-swappable batteries for extended flight operation.

The fire extinguishing unmanned aerial vehicle system according to any of the preceding clauses, wherein the controller is further configured to optimize flight paths to minimize battery consumption based on payload weight and projectile deployment rate.

A fire extinguishing unmanned aerial vehicle system including an unmanned aerial vehicle (UAV), a projectile launcher, a processor, and a memory. The projectile launcher is secured to the UAV and configured to support a plurality of projectiles, wherein at least one of the projectiles includes a fire-extinguishing material. The memory stores instructions, which, when executed by the processor, cause the fire extinguishing unmanned aerial vehicle system to: identify a location of a fire and selectively discharge at least one projectile from the projectile launcher toward the fire to apply fire-extinguishing material to the fire.

The fire extinguishing UAV system according to the preceding clause, wherein the UAV includes a plurality of foldable arms that transition between a retracted position for compact storage and an extended position for flight.

The fire extinguishing unmanned aerial vehicle system according to any of the preceding clauses, wherein each foldable arm supports a motor and propeller assembly configured to enable flight of the UAV.

The fire extinguishing unmanned aerial vehicle system according to any of the preceding clauses, wherein the projectile launcher includes an indexing assembly configured to sequentially position the plurality of projectiles for deployment.

The fire extinguishing unmanned aerial vehicle system according to any of the preceding clauses, wherein the indexing assembly includes a rotatable indexer configured to selectively advance successive projectiles into a firing position in response to actuation of a servo motor coupled to the rotatable indexer.

The fire extinguishing unmanned aerial vehicle system according to any of the preceding clauses, wherein the projectile launcher includes a firing assembly having a motorized firing wheel, wherein the motorized firing wheel is configured to impart a rotational force onto each projectile to propel the projectile from the projectile launcher.

The fire extinguishing unmanned aerial vehicle system according to any of the preceding clauses, further comprising a sensor assembly configured to capture real-time images of the fire.

The fire extinguishing unmanned aerial vehicle system according to any of the preceding clauses, wherein the at least one projectile includes a first projectile configured to break a window in a structure and a second projectile that includes the fire-extinguishing material, the second projectile being configured to be deployed through the window when the window is broken or open to provide horizontal ventilation or access to the fire within the structure.

The fire extinguishing unmanned aerial vehicle system according to any of the preceding clauses, wherein the UAV includes hot-swappable batteries for extended flight operation.

A method for fire extinguishing using an unmanned aerial vehicle (UAV) system, the method comprising: targeting at least one window with a sensor system of a UAV, selectively discharging at least one projectile from a projectile launcher of the UAV toward the at least one window, and selectively breaking the at least one window with the at least one projectile and/or applying fire extinguishing material to a fire with the at least one projectile after the at least one projectile is discharged from the projectile launcher.

As can be appreciated, securement of any of the components of the disclosed systems can be effectuated using known securement techniques such welding, crimping, gluing, fastening, injection molding, cast-in-place, etc.

The phrases “in an aspect,” “in aspects,” “in various aspects,” “in some aspects,” or “in other aspects” may each refer to one or more of the same or different aspects in accordance with the present disclosure. Similarly, the phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A fire extinguishing unmanned aerial vehicle system, the system comprising:
an unmanned aerial vehicle (UAV);
a projectile launcher secured to the UAV and configured to support a plurality of projectiles, wherein at least one of the projectiles includes a fire-extinguishing material; and
a controller operatively coupled to the UAV and the projectile launcher, wherein the controller is configured to selectively discharge at least one projectile of the plurality of projectiles from the projectile launcher to break a window in a structure or apply fire extinguishing material to a fire in the structure with the at least one projectile.

2. The fire extinguishing unmanned aerial vehicle system of claim 1, wherein the UAV includes a plurality of foldable arms that transition between a retracted position for compact storage and an extended position for flight.

3. The fire extinguishing unmanned aerial vehicle system of claim 2, wherein each foldable arm supports a motor and propeller assembly configured to enable flight of the UAV.

4. The fire extinguishing unmanned aerial vehicle system of claim 1, wherein the projectile launcher includes an indexing assembly configured to sequentially position the plurality of projectiles for deployment.

5. The fire extinguishing unmanned aerial vehicle system of claim 4, wherein the indexing assembly includes a rotatable indexer configured to selectively advance successive projectiles into a firing position.

6. The fire extinguishing unmanned aerial vehicle system of claim 1, wherein the projectile launcher includes a firing assembly having a firing wheel, wherein the firing wheel is configured to impart a rotational force onto each projectile to propel the projectile from the projectile launcher.

7. The fire extinguishing unmanned aerial vehicle system of claim 1, further comprising a camera assembly configured to capture real-time images of a fire.

8. The fire extinguishing unmanned aerial vehicle system of claim 1, wherein the plurality of projectiles includes a first projectile configured to break the window in the structure and a second projectile that includes the fire-extinguishing material, the second projectile is configured to be deployed through the window when the window is broken or open to provide horizontal ventilation or access to the fire within the building.

9. The fire extinguishing unmanned aerial vehicle system of claim 1, wherein the UAV comprises a dual battery system including hot-swappable batteries for extended flight operation.

10. The fire extinguishing unmanned aerial vehicle system of claim 1, wherein the controller is further configured to optimize flight paths to minimize battery consumption based on payload weight and projectile deployment rate.

11. A fire extinguishing unmanned aerial vehicle system, the system comprising:
an unmanned aerial vehicle (UAV);
a projectile launcher secured to the UAV and configured to support a plurality of projectiles, wherein at least one of the projectiles includes a fire-extinguishing material; and
a processor; and
a memory storing instructions, which, when executed by the processor, cause the fire extinguishing unmanned aerial vehicle system to:
identify a location of a fire; and
selectively discharge at least one projectile from the projectile launcher toward the fire to apply fire-extinguishing material to the fire.

12. The fire extinguishing UAV system of claim 1, wherein the UAV includes a plurality of foldable arms that transition between a retracted position for compact storage and an extended position for flight.

13. The fire extinguishing unmanned aerial vehicle system of claim 12, wherein each foldable arm supports a motor and propeller assembly configured to enable flight of the UAV.

14. The fire extinguishing unmanned aerial vehicle system of claim 11, wherein the projectile launcher includes an indexing assembly configured to sequentially position the plurality of projectiles for deployment.

15. The fire extinguishing unmanned aerial vehicle system of claim 14, wherein the indexing assembly includes a rotatable indexer configured to selectively advance successive projectiles into a firing position in response to actuation of a servo motor coupled to the rotatable indexer.

16. The fire extinguishing unmanned aerial vehicle system of claim 11, wherein the projectile launcher includes a firing assembly having a motorized firing wheel, wherein the motorized firing wheel is configured to impart a rotational force onto each projectile to propel the projectile from the projectile launcher.

17. The fire extinguishing unmanned aerial vehicle system of claim 11, further comprising a sensor assembly configured to capture real-time images of the fire.

18. The fire extinguishing unmanned aerial vehicle system of claim 11, wherein the at least one projectile includes a first projectile configured to break a window in a structure and a second projectile that includes the fire-extinguishing material, the second projectile being configured to be deployed through the window when the window is broken or open to provide horizontal ventilation or access to the fire within the structure.

19. The fire extinguishing unmanned aerial vehicle system of claim 11, wherein the UAV includes hot-swappable batteries for extended flight operation.

20. A method for fire extinguishing using an unmanned aerial vehicle (UAV) system, the method comprising:
targeting at least one window with a sensor system of a UAV;
selectively discharging at least one projectile from a projectile launcher of the UAV toward the at least one window; and
selectively breaking the at least one window with the at least one projectile and/or applying fire extinguishing material to a fire with the at least one projectile after the at least one projectile is discharged from the projectile launcher.
